(19) United States
(12) Patent Application Publication
(10) Pub. No.: US 2013/0050122 A1
(43) Pub. Date: Feb. 28, 2013

(54) CONTROLLING USER EQUIPMENT AS TOUCH PAD FOR EXTERNAL DEVICE CONNECTED THERETO

(71) Applicants: You-Jin KANG, Seoul (KR); Shin-Hyuk Kang, Seoul (KR); Jung-Wook Lee, Gyeonggi-do (KR); Jae-Hun Jung, Gyeonggi-do (KR); Jae-Uk Cha, Gyeonggi-do (KR)

(72) Inventors: You-Jin KANG, Seoul (KR); Shin-Hyuk Kang, Seoul (KR); Jung-Wook Lee, Gyeonggi-do (KR); Jae-Hun Jung, Gyeonggi-do (KR); Jae-Uk Cha, Gyeonggi-do (KR)

(21) Appl. No.: 13/598,741

(22) Filed: Aug. 30, 2012

(30) Foreign Application Priority Data
Aug. 31, 2011 (KR) 10-2011-0088169

(51) Int. Cl. G06F 3/041

(52) U.S. Cl. 345/173

(57) ABSTRACT

Provided is a method for controlling user equipment as a touch pad for an external device connected to the user equipment. An operation mode may be changed to a pointing device operation mode when the user equipment is coupled to the external device. In the pointing device operation mode, a touch input may be received through a touch screen panel of the user equipment. A pointer may be displayed on a display unit of the external device corresponding to a coordinate value of the touch input made on the touch screen panel. An operation associated with the received touch input may be performed in the user equipment.

### CROSS REFERENCE TO PRIOR APPLICATIONS

The present application claims priority under 35 U.S.C. §119 to Korean Patent Application No. 10-2011-0088169 (filed on Aug. 31, 2011), which is hereby incorporated by reference in its entirety.

The subject matter of this application is related to U.S. patent application Ser. No. 13/540,112 filed Jul. 2, 2012, as Attorney Docket No.: (801.0050), U.S. patent application Ser. No. 13/539,929 filed Jul. 2, 2012, as Attorney Docket No.: (801.0051), and U.S. patent application Ser. No. 13/460,091 filed Apr. 30, 2012, as Attorney Docket No.: (801.0061), the teachings of which are incorporated herein their entirety by reference.

### FIELD OF THE INVENTION

The present invention relates to user equipment and in particular, to controlling user equipment as a touch pad for an external device when the user equipment is coupled to the external device.

### BACKGROUND OF THE INVENTION

User equipment has advanced so as to perform multiple functions such as communicating voice and data with others; exchanging text messages or multimedia messages; sending e-mails; capturing a still or moving image; playing back a music or a video file, playing a game, and a receiving a broadcast signal. Lately, such multi-functional user equipment has received greater attention for new applications. Instead of using multiple independent devices, a user prefers to use single multifunction-enabled user equipment. Portability and/or mobility should be considered in design of user equipment, but such user equipment has limitations in size. Accordingly, there also are limitations in display screen size, screen resolution, and speaker performance.

In order to overcome such limitations, an external device having a large display size, better speaker performance, and connectable to a mobile terminal has been introduced. Such external device connected to the mobile terminal can provide data, music files, and other content stored in the mobile terminal in better performance Accordingly, there is a demand for developing technologies in hardware and software to support interactions between the mobile terminal and the connected external device.

### SUMMARY OF THE INVENTION

This summary is provided to introduce a selection of concepts in a simplified form that are further described below in the detailed description with reference to the drawings. This summary is not intended to identify key features or essential features of the claimed subject matter, nor is it intended to limit the scope of the claimed subject matter. Embodiments of the present invention overcome the above disadvantages and other disadvantages not described above. Also, the present invention is not required to overcome the disadvantages described above, and an embodiment of the present invention may not overcome any of the problems described above.

In accordance with an aspect of the present invention, user equipment may operate as a touch pad for an external device when the user equipment is connected to the external device.

In accordance with another aspect of the present invention, user equipment may receive touch inputs from a user through a touch screen panel, perform operations associated with the received touch inputs, and control a connected external device to display a pointer corresponding to the received touch inputs and a result of performing the operations.

In accordance with an embodiment of the present invention, a method may be provided for controlling user equipment as a touch pad for an external device connected to the user equipment. The method may include changing an operation mode to a pointing device operation mode when the user equipment is coupled to the external device, receiving a touch input through a touch screen panel of the user equipment, displaying a pointer on a display unit of the external device corresponding to a coordinate value of the touch input made on the touch screen panel, and performing an operation associated with the received touch input.

The changing may include detecting that a physical connection is established between the user equipment and the external device based on a detection signal generated in a port unit of the user equipment and automatically initiating the pointing device operation mode upon the detection of the physical connection.

The changing may include detecting that a physical connection is established between the user equipment and the external device based on a detection signal generated in a port unit of the user equipment, determining whether an initiation input is received after the detecting of the physical connection, initiating the pointing device operation mode when the initiation key is received, otherwise, performing operations in response to events generated after the physical connection.

The initiation key may be at least one of buttons and keys of the user equipment and the external device, at least one of icons and widgets displayed on a graphic user interface displayed on the display device of the external device, or any combination of the buttons, the keys, the icons, and the widgets.

The changing may include turning off a display unit of the user equipment and starting transmitting image data created in the user equipment to the external device and maintaining the touch screen panel in turning on and waiting for an input;

The receiving a touch input includes determining a type of an input when the input is received after initiating the pointing device operation mode. When the type of the received input is the touch input, a type of the received touch input may be determined, a pointer may be displayed on the display unit of the external device based on coordinate value of the touch input made on the touch screen panel of the user equipment, and an operation associated with the determined type of the touch input may be performed. The type of the input may be determined as the touch input when the input is made on the touch screen panel of the user equipment. The touch input may include a signal tap input, a double tap input, a long press input, a tap and drag input, a drag and drop input, and a copy and paste input.

The displaying a pointer may include obtaining a coordinate value of the touch input made on the touch screen panel of the user equipment, calculating coordinate information of the pointer to be displayed on the display unit of the external device based on the obtained coordinate value, creating image data for displaying the pointer on the display unit of the external device based on the calculated coordinate information, transmitting the created image data to the external device, and controlling the external device to display the created image on the display unit of the external device.

The displaying a pointer may include obtaining a coordinate value of the touch input made on the touch screen panel of the user equipment, transmitting the obtained coordinate value of the touch input to the external device, controlling the external device to calculate coordinate information of the pointer to be displayed on the display unit of the external device based on the transmitted coordinate value, controlling the external device to create image data for displaying the pointer on the display unit of the external device based on the calculated coordinate information, and controlling the external device to display the created image data on the display unit of the external device.

The displaying a pointer may include obtaining a coordinate value of the touch input made on the touch screen panel of the user equipment, calculating coordinate information of the pointer to be displayed on the display unit of the external device based on the obtained coordinate value, transmitting the calculated coordinate information of the pointer to the external device, controlling the external device to create image data for displaying the pointer on the display unit of the external device based on the calculated coordinate information, and controlling the external device to display the created image data on the display unit of the external device.

One of an absolute coordinate mode and a relative coordinate mode may be used to obtain the coordinate value and to calculate the coordinate information.

The method may further include changing an absolute coordinate mode for displaying a pointer corresponding to a touch input to a relative coordinate mode after the user equipment is connected to the external device.

In accordance with another embodiment of the present invention, a user equipment may operate as a touch pad for an external device connected to the user equipment. The user equipment may include a port unit, a display unit, and a controller. The port unit may be configured to be connected to a corresponding port unit of the external device and to generate a detection signal when the user equipment is coupled to the external device. The display unit may be configured to include a touch screen panel and to receive a touch input from a user through the touch screen panel. The controller may be configured to initiate a pointing device operation mode when the port unit generates the detection signal. In the pointing device operation mode, the controller may be configured to receive touch inputs through the touch screen panel from a user, to control the external device to display a pointer corresponding to the received touch input, to perform operations associated with the received touch inputs, and to control the external device to display a result of performing the operations.

The controller may be configured to initiate the pointing device operation mode when a certain input is received after the user equipment is connected to the external device.

The user equipment may further include a display controller and a touch screen panel controller. The display controller may be configured to turn off the display unit of the user equipment in response to the control of the controller when the pointing device operation mode is initiated. The touch screen panel controller may be configured to maintain the touch screen panel in turning on in response to the control of the controller when the pointing device operation mode is initiated.

The controller may be configured to obtain a coordinate value of the touch input made on the touch screen panel, calculate coordinate information of the pointer to be displayed on the display unit of the external device based on the obtained coordinate value, create image data for displaying the pointer on the display unit of the external device based on the calculated coordinate information, transmit the created image data to the external device, and control the external device to display the created image on the display unit of the external device. Furthermore, the controller may be configured to obtain a coordinate value of the touch input made on the touch screen panel of the user equipment, transmit the obtained coordinate value of the touch input to the external device, control the external device to calculate coordinate information of the pointer to be displayed on the display unit of the external device based on the transmitted coordinate value, control the external device to create image data for displaying the pointer on the display unit of the external device based on the calculated coordinate information, and control the external device to display the created image data on the display unit of the external device.

### BRIEF DESCRIPTION OF THE DRAWINGS

The above and/or other aspects of the present invention will become apparent and more readily appreciated from the following description of embodiments, taken in conjunction with the accompanying drawings, of which:

FIG. 1 shows user equipment in accordance with embodiments of the present invention;

FIG. 2 and FIG. 3 show an external device connectable to user equipment in accordance with embodiments of the present invention;

FIG. 4 shows user equipment coupled to an external device in a docking manner in accordance with embodiments of the present invention;

FIG. 5 shows various coupling manners of user equipment and an external device;

FIG. 6 is a block diagram illustrating user equipment in accordance with embodiments of the present invention;

FIG. 7 shows an external device in accordance with embodiments of the present invention;

FIG. 8 shows a port unit of user equipment in accordance with an embodiment of the present invention;

FIG. 9 shows a method of controlling user equipment as a touch pad for an external device connected to the user equipment in accordance with embodiments of the present invention; and

FIG. 10 and FIG. 11 show operations of user equipment for providing an operation environment through an external device connected to the user equipment in accordance with embodiments of the present invention.

### DETAILED DESCRIPTION OF THE INVENTION

Reference will now be made in detail to embodiments of the present invention, examples of which are illustrated in the accompanying drawings, wherein like reference numerals refer to like elements throughout. The embodiments are described below, in order to explain the present invention by referring to the figures.

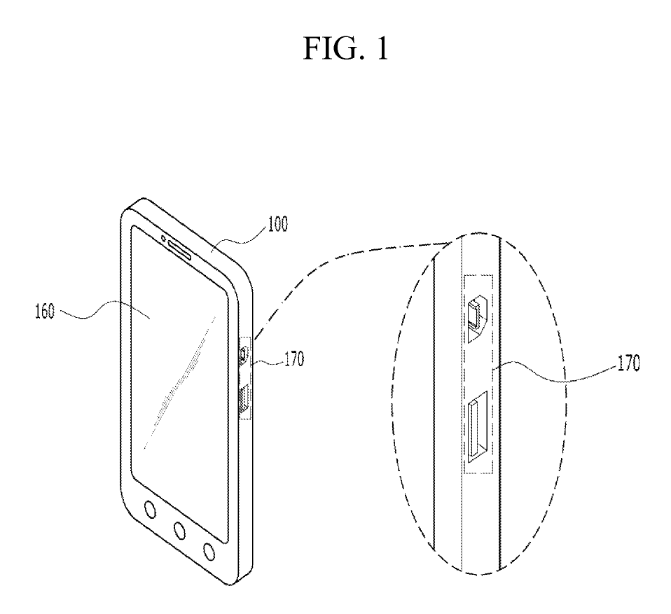

FIG. 1 shows user equipment in accordance with embodiments of the present invention.

Referring to FIG. 1, user equipment 100 may include display unit 160 and at least one port unit 170. Display unit 160 may display data according to display setting of user equipment 100. Display unit 160 may typically have about 4.5 inch display area which may be smaller than that of an external device, but the present invention is not limited thereto. For example, a display area of an external device may be smaller than that of user equipment 100.

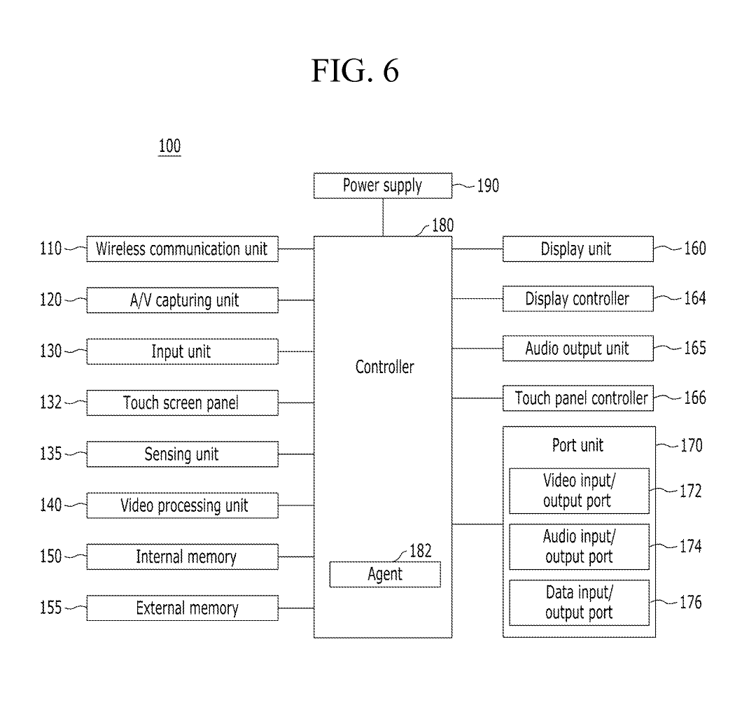

At least one port unit 170 may be coupled to an external device and exchange data with the external device. User equipment 100 may be capable of processing data and transferring the processed data to an external device through port unit 170. Such a port unit 170 may include a high definition multimedia interface (HDMI) port and/or a universal serial bus (USB) port, but the present invention is not limited thereto. User equipment 100 may have a certain design or standardized interface connectable to an external device. For example, user equipment 100 may be attachable to and/or detachable from an external device. User equipment 100 may dock to an external device. User equipment 100 may be any electronic device that can perform the above and further operations described herein. For example, user equipment 100 may include, but is not limited to, a mobile terminal, a mobile device, a mobile phone, a portable terminal, a portable device, a handheld device, a cellular phone, a smart phone, a personal digital assistant (PDA), wireless local loop (WLL) station, a portable multimedia player (PMP), and a navigation device. The present invention, however, is not limited thereto, and other types of user equipment, such as mini-laptop PCs and other computing devices may incorporate embodiments of the present invention. User equipment 100 will be described in more detail with reference to FIG. 6.

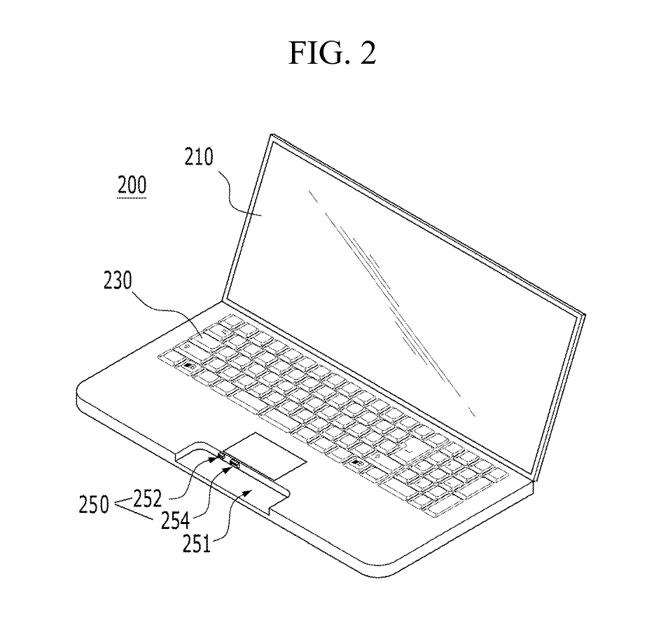

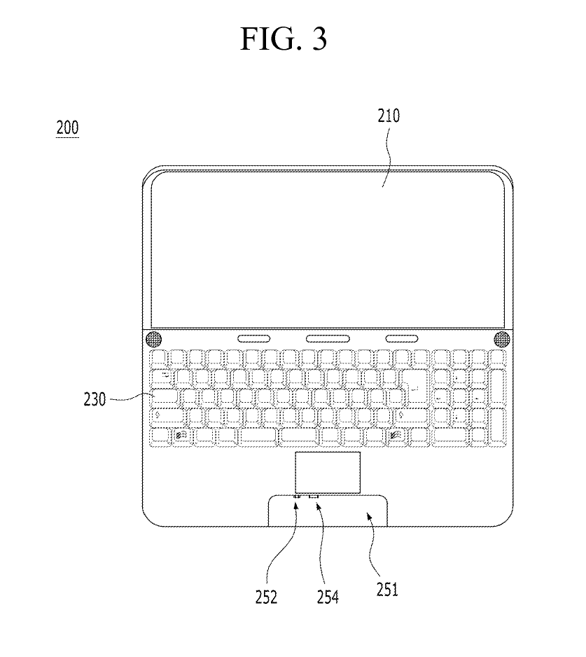

FIG. 2 and FIG. 3 show an external device connectable to user equipment in accordance with embodiments of the present invention.

Referring to FIG. 2 and FIG. 3, external device 200 may include display unit 210, keypad 230, and at least one pot unit 250.

Display unit 210 may display data. Display unit 210 may have a display area larger than that of user equipment 100. For example, display unit 210 may have about 10.1 inch of display area. The present invention, however, is not limited thereto. External device 200 may have a display area smaller than that of user equipment 100.

At least one port unit 250 may be coupled to corresponding port unit 170 of exchanging data with user equipment 100. Accordingly, at least one port unit 250 may include a HDMI port and/or a USB port corresponding to port unit 170 of user equipment 100. External device 200 may be capable of receiving data from user equipment 100 through at least one port unit 250 and displaying the received data on display unit 210. External device 200 may have a certain design connectable to user equipment 100 through at least one port unit 250. For example, external device 200 may be attachable to and/or detachable from user equipment 100 as described above with respect to FIG. 1. External device 200 may have a structure for receiving and holding user equipment 100. Such a structure may be referred to as coupling bay 251. External device 200 may be any electronic device that can perform the above operation. For example, external device 200 may include a notebook computer, a laptop computer, a tablet PC, a pad having a touch screen, and a pad having a display unit and a keyboard, but the present invention is not limited thereto. In accordance with an embodiment of the present invention, external device 200 may be activated when user equipment 100 is connected to external device 200 and controlled by user equipment 100. Accordingly, external device 200 may have at least constituent elements for necessary operation performed under the control of user equipment 100.

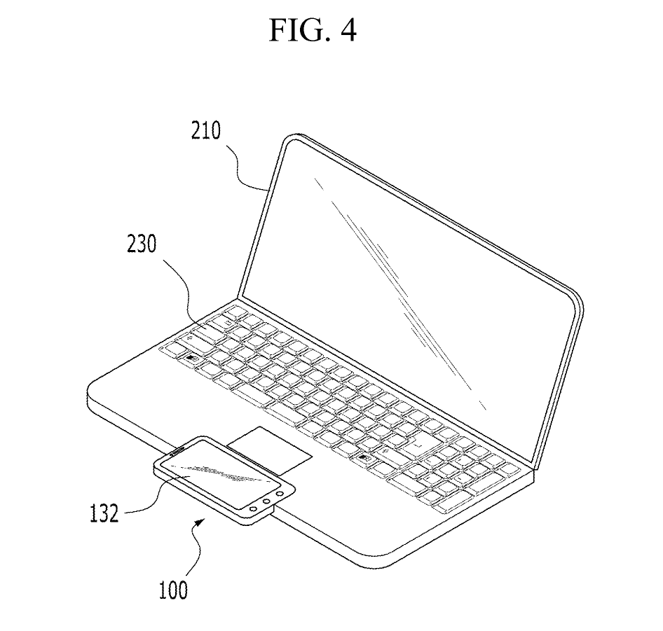

As described above, user equipment 100 may be coupled to external device 200. For example, at least one port unit 170 of user equipment 100 may be coupled to at least one port unit 250 of external device 200. In accordance with an embodiment of the present invention, user equipment 100 may be coupled to external device 200 in a docking manner. Such coupling manner will be described with reference to FIG. 4.

FIG. 4 shows user equipment coupled to an external device in a docking manner in accordance with embodiments of the present invention.

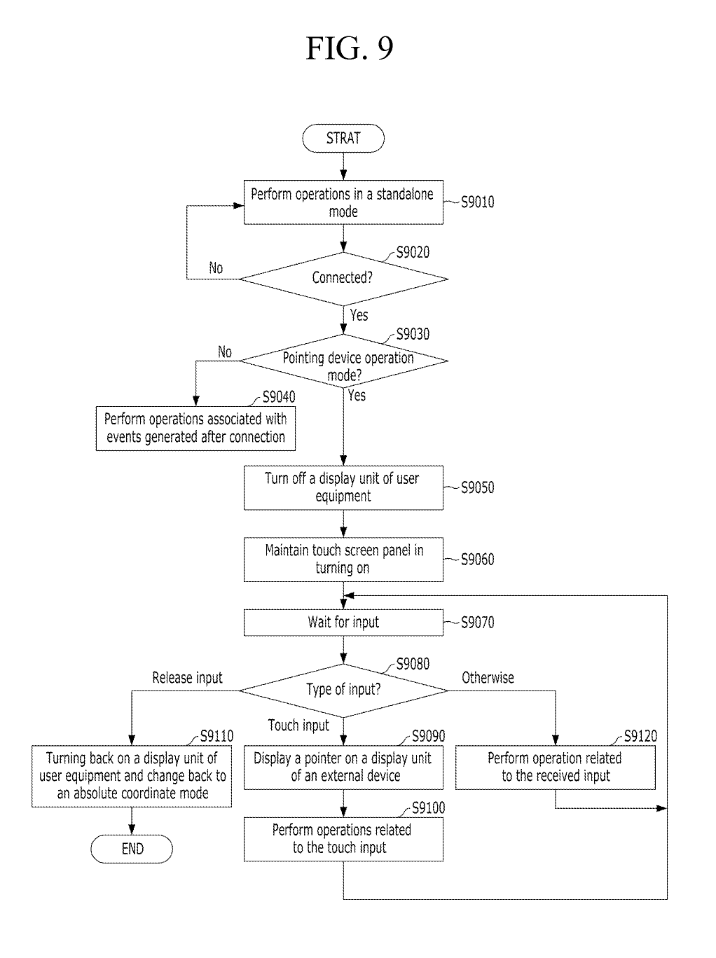

Referring to FIG. 4, user equipment 100 may be docked at coupling bay 251 of external device 200. Particularly, user equipment 100 may be inserted into coupling bay 251. When user equipment 100 is inserted into coupling bay 251 of external device 200, port unit 170 of user equipment 100 may be coupled with corresponding port unit 250 of external device 200. Upon the connection, a host-device connection may be established between user equipment 100 and external device 200 in accordance with embodiments of the present invention. Particularly, user equipment 100 may operate as a touch pad for external device 200 when user equipment 100 is connected to external device 200 in accordance with embodiments of the present invention. Such operation will be described in detail with reference to FIG. 9 to FIG. 11.

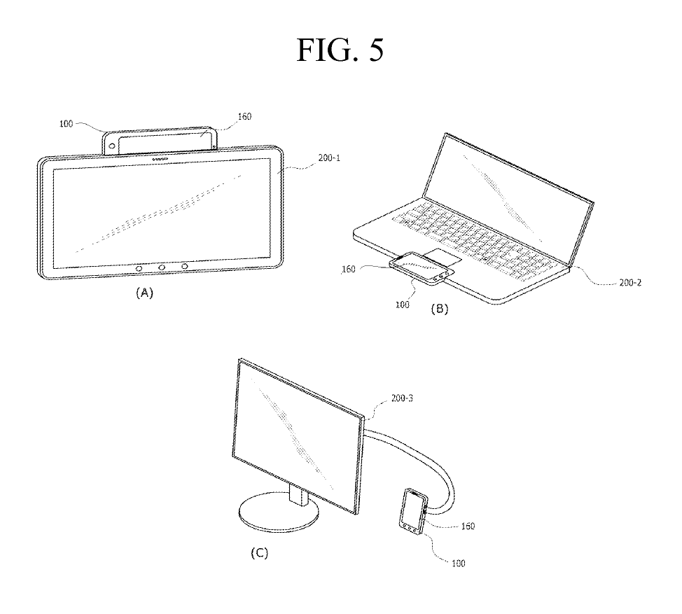

For convenience and ease of understanding, external device 200 will be described as a laptop computer. The present invention, however, is not limited thereto. User equipment 100 may be coupled to various types of external devices. Furthermore, user equipment 100 may be coupled to external device 200 through various coupling manner. Such coupling manners will be described with reference to FIG. 5.

FIG. 5 shows various coupling manners of user equipment and an external device.

Referring to FIG. 5, user equipment 100 may be coupled to a pad type device 200-1 in a docking manner as show in a diagram (A). Furthermore, user equipment 100 may be coupled to a laptop computer 200-2 in a docking manner as show in a diagram (B). User equipment 100 may be coupled to a monitor 200-3 through a physical cable as shown in a diagram (C).

As shown, user equipment 100 may be coupled to an external device in various manners. After user equipment 100 is coupled to the external device, user equipment 100 may exchange data with external device 200 through port units 170 and 250. In accordance with embodiments of the present invention, user equipment 100 may control external device 200 by exchanging data through a communication link formed between port unit 170 of user equipment 100 and port unit 250 of external device 200.

Hereinafter, user equipment 100 will be described in more detail with reference to FIG. 6. As described above, user equipment 100 may be coupled to external device 200 and operate as a touch pad for external device 200 in accordance with an embodiment of the present invention.

FIG. 6 is a block diagram illustrating user equipment in accordance with embodiments of the present invention.

Referring to FIG. 6, user equipment 100 may include wireless communication unit 110, audio/video (A/V) input unit 120, input unit 130, sensing unit 135, video processing unit 140, internal memory 150, external memory 155, display unit 160, display controller 164, audio output unit 165, touch panel controller 166, port unit 170, controller 180, and power supply 190. Input unit 130 may include touch screen panel 132. Controller 180 may include an agent 182. Port unit 170 may include video input/output port 172, audio input/output port 174, and data input/output port 176. Power supply unit 190 may include a battery for electric charging. User equipment 100 may be described as including the above constituent elements, but the present invention is not limited thereto.

Wireless communication unit 110 may include at least one module for communicating with other party through a wireless communication system. For example, wireless communication unit 110 may include any or all of a broadcasting signal receiving module, a mobile communication module, a wireless Internet module, a short-distance communication module, and a location information module. In accordance with an embodiment of the present invention, wireless communication unit 110 may be not an essential unit for user equipment 100 because user equipment 100 may be not required to communicate with another party. Accordingly, wireless communication unit 110 may be omitted in accordance with another embodiment of the present invention.

A/V capturing unit 120 may capture an audio signal and/or a video signal. For example, the A/V input unit 120 may include a camera and a microphone. The camera may process image frames of a still image or a moving image, which are captured by an image sensor in a video call mode or a photographing mode. The microphone may receive an audio signal provided externally in an on-call mode, a recording mode, or a voice recognition mode.

Input unit 130 may be a user interface for receiving input from a user. Such an input unit 130 may be realized in various types. For example, input unit 130 may include any of a keypad, a dome switch, a touch pad, a jog wheel, and a jog switch, but is not limited thereto.

In accordance with embodiments of the present invention, user equipment 100 may be a full touch type smart phone. In this case, input unit 130 may include several hardware key buttons and a touch screen. The hardware key buttons may include a hold key and a volume control button. Touch screen panel 132 may be another input unit for receiving touch inputs in accordance with embodiments of the present invention. Touch screen panel 132 may be disposed on an upper surface of display unit 160, but the present invention is not limited thereto.

Sensing unit 135 may detect a current status of user equipment 100. For example, sensing unit 135 may sense an opening or closing of a cover of user equipment 100, a location and a bearing of user equipment 100, acceleration and deceleration of user equipment 100, or physical contact with or proximity to a user. Based on the detected status of user equipment 100, sensing unit 135 may generate a sensing signal to control the operation of user equipment 100. For example, in the case of a mobile phone having a sliding type cover, sensing unit 135 may sense whether a cover is opened or closed. Sensing unit 135 may sense whether or not power supply 190 supplies power. Furthermore, sensing unit 135 may sense whether or not port unit 170 is coupled to external device 200. In this case, sensing unit 135 may receive a detection signal from port unit 170 when user equipment 100 is connected to external device 200 in accordance with an embodiment of the present invention. For example, sensing unit 135 may receive a detection signal from a hot plug detect (HPD) pin when port unit 170 includes a HDMI port. Based on the detection signal, controller 180 may determine that external device 200 is connected to user equipment 100. Upon the receipt of the detection signal, user equipment 100 may initiate a pointing device operation mode in accordance with embodiments of the present invention. In this pointing device operation mode, user equipment 100 may operate as a touch pad for external device 200 connected to user equipment 100.

Video processing unit 140 may process an image signal and/or image data under the control of controller 180. Particularly, video processing unit 140 may process image data according to a display setting determined based on display unit information of display unit 160. The display setting may include a screen size, a screen resolution, a display direction, and a dot per inch (DPI) value. The display setting may be determined by controller 180 based on display unit information of display unit 160. The display unit information may include a manufacturer, a model number, a device identifier (ID), a DPI value, a screen size, the number of pixels, supporting screen resolutions, supporting aspect ratios, refresh rates, and a response time. Video processing unit 140 may transmit the processed image data to display unit 160 of user equipment 100 in response to controller 180. Furthermore, video processing unit 140 may process image data to be transmitted to external device 200 when user equipment 100 is connected to external device 200. For example, video processing unit 140 may, reconfigure image data based on a display setting of external device 200 and generate a signal based on the reconfigured image data in response to controller 180. The present invention, however, is not limited thereto. Such an operation may be performed by controller 180. The image data may be data for displaying a graphic user interface produced by any software programs installed in user equipment 100, such as an operating system and applications installed in user equipment 100.

Internal memory 150 and external memory 155 may be used as a data storage device of user equipment 100. For example, internal memory 150 and external memory 155 may store information necessary for operating user equipment 100 and performing certain operations requested by a user. Such information may include any software programs and related data. For example, internal memory 150 and external memory 155 may store an operation system data, applications, and related data, received from an external device through a physical cable and downloaded from a related server from through a communication link. In accordance with embodiments of the present invention, internal memory 150 and/or external memory 155 may store information on display setting determined for display unit 160 or display unit 210 of external device 200. Furthermore, internal memory 150 and external memory 155 may store device unit information for candidate external devices connectable to user equipment 100. In addition, internal memory 150 and/or external memory 150 may store a DPI table (not shown). Internal memory 150 may be a flash memory, hard disk, multimedia card micro memory, SD or XD memory, Random Access Memory (RAM), Static Random Access Memory (SRAM), Read-Only Memory (ROM), Programmable Read-Only Memory (PROM), Electrically Erasable Programmable Read-Only Memory (EEPROM), magnetic memory, magnetic disk, or optical disk, but is not limited thereto. External memory 155 may be a SD card or a USB memory, but the present invention is not limited thereto. For example, external device 200 may function as external memory 155 when external device 200 is coupled to user equipment 100 in accordance with an embodiment of the present invention.

Display unit 160 may be an output device for visually displaying information. For example, display unit 160 may display image data produced or processed by video processing unit 140 and/or controller 180. Display unit 160 may receive the image data from at least one of video processing unit 140 and controller 180 and display the received image data. The image data may be produced as a result of certain operations performed by any software programs installed in user equipment 100. For example, the image data may be data processed for displaying a graphic user interface produced by an operation system and applications, performed in user equipment 100. The applications may be referred to as App. Also, the image data may further include still images and moving images, produced or processed by video processing unit 140 and controller 180. For example, display unit 160 may be a liquid crystal display (LCD) panel or an active-matrix organic light-emitting diode (AMOLED) panel, but the present invention is not limited thereto.

In accordance with embodiments of the present invention, display unit 160 may be interrupted to display the image data when user equipment 100 is connected to external device 200. For example, display unit 160 may be turned off or transit to a sleep mode in response to controller 180 when user equipment 100 is connected to external device 200. Display unit 160 may be turned on again or transit back to an operation mode in response to controller 180 when user equipment 100 is disconnected from external device 200. That is, display unit 160 may be turned off in the pointing device operation mode in accordance with embodiments of the present invention. After turning off display unit 160, controller 180 may transmit image data to external device 200 for displaying on the image data on display unit 210 of external device 200.

Audio output unit 165 may provide an output audio signal that may be produced or processed by controller 180 as a result of operations performed by an operating system and/or applications installed in user equipment 100. Audio output unit 165 may include a speaker, a receiver, and a buzzer.

Port unit 170 may include at least one port for exchanging signals and/or data with external device 200. In accordance with embodiments of the present invention, port unit 170 may transfer image data and audio data from user equipment 100 to external device 200. Port unit 170 may exchange control data with external device 200. Port unit 170 may be coupled to corresponding port unit 250 of external device 200 in various coupling manners. For example, port unit 170 may be coupled to corresponding port unit 250 of external device 200 through a physical cable. Furthermore, port unit 170 may be directly interlocked with corresponding port unit 250 of external device 200. The present invention, however, is not limited thereto. Port unit 170 may be coupled to corresponding port unit 250 of external device 200 through a radio link formed between user equipment 100 and external device 200. In this case, port unit 170 and port unit 250 may include a signal transmitter and receiver (not shown) for communicating with each other using a communication protocol. Such communication protocol may be Bluetooth, but the present invention is not limited thereto.

As shown in FIG. 6, port unit 170 may include video input/output port 172, audio input/output port 174, and data input/output port 176, but the present invention is not limited thereto. Such port unit 170 may be embodied in various types. For example, port unit 170 may not include audio input/output interface 174. Further, port unit 170 may include a power port (not shown). In this case, the power port may transfer power from external device 200 to user equipment 100 when external device 200 is coupled to user equipment 100.

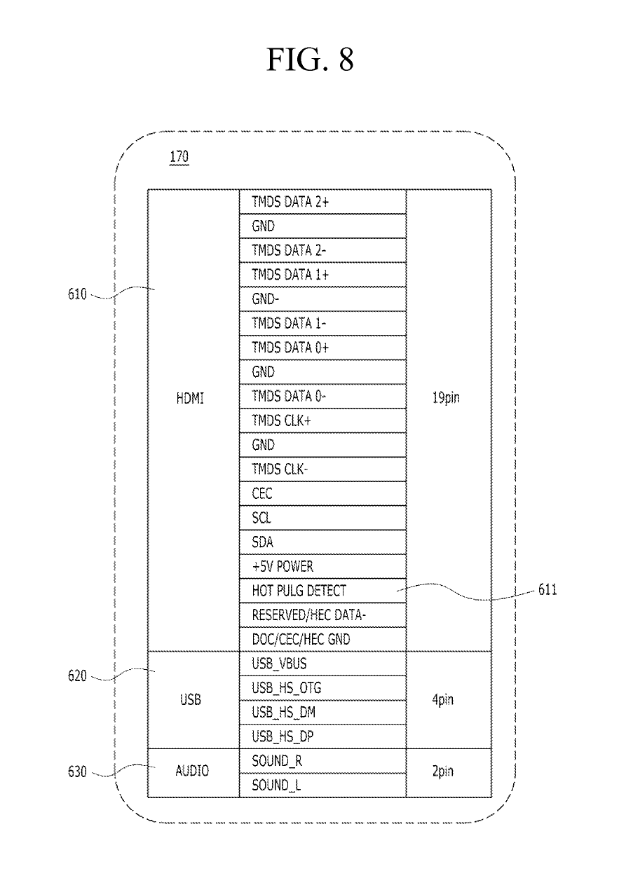

Port unit 170 will be described in detail with reference to FIG. 8 in later. Referring to FIG. 8, port unit 170 may be an interface for inputting and outputting audio and video signals and control signals. Port unit 170 may include high definition multimedia interface (HDMI) port 610, universal serial bus (USB) port 620, and audio port 630. For example, video input/output port 172 may be HDMI port 610, audio input/output port 174 may be audio port 630, and data input/output pot 176 may be USB port 620 (see FIG. 6). The present invention, however, is not limited thereto. In another embodiment of the present invention, port unit 170 may include other types of connectors and ports.

In accordance with an embodiment of the present invention, user equipment 100 may be coupled to external device 200 through port unit 170. After user equipment 100 coupled to external device 200, user equipment 100 may control external device 200 by exchanging data with external device 200 through port unit 170. For example, user equipment 100 may receive inputs from a user through external device 170 and transmit control data to external device 170 through port unit 170. Particularly, user equipment 100 may transmit image data through port unit 170 to external device 200 and control external device 200 to display the image data such a graphic user interface instead of display unit 160 of user equipment 100. Furthermore, after user equipment 100 is coupled to external device 200, user equipment 100 may operate as a touch pad for external device 200 in accordance with embodiments of the present invention. That is, user equipment 100 may receive touch inputs through touch screen panel 132 and control external device 200 to display a pointer and a result of performing operations related to the received touch inputs.

Returning to FIG. 6, controller 180 may control overall operation of the constituent elements of user equipment 100. Particularly, controller 180 may perform operations necessary for driving the constituent elements of user equipment 100 in response to inputs received from a related user. In accordance with embodiments of the present invention, controller 180 may control overall operation of constituent elements of external device 200 when user equipment 100 is connected to external device 200. For example, controller 180 may receive inputs through external device 200, perform an operation in response to the received inputs, and provide the user with the result thereof through external device 200. Particularly, controller 180 may display image data, as a result of operation related to the user inputs, on a display unit of external device 200 when user equipment 100 is connected to external device 200. In order to display the image data on external device 200, controller 180 may include agent 182. Agent 182 may control operations related to connection to external device 200 and controlling external device 200. Such agent 182 may be referred to as a coupling agent or a docking agent, but the present invention is not limited thereto. Agent 182 may be implemented in software. For example, agent 182 may be realized on an application layer in an operating system (OS) structure of user equipment 100. For example, such an OS structure may be an OS structure of an android operating system, but present invention is not limited thereto.

In accordance with embodiments of the present invention, controller 180 may perform operations for operating user equipment 100 as a touch pad for external device 200 when user equipment 100 is connected to external device 200. For example, controller 180 may determine whether user equipment 100 is connected to external device 200 based on a detection signal generated in port unit 170. When user equipment 100 is connected to external device 200, controller 180 may initiate a pointing device operation mode. In the pointing device operation mode, controller 180 may control constituent elements of user equipment 100 to operate as a touch pad for external device 200. For example, controller 180 may control display controller 164 to turn off display unit 160. Furthermore, controller 180 may control touch panel controller 166 to maintain touch screen panel 132 in turning-on when the pointing device operation mode is initiated.

When a user enters touch input through touch screen panel 132, controller 180 may i) determine a type of touch input made on touch screen panel 132, ii) display a pointer or a cursor on display unit 210 of external device 200 based on coordinate values of touch inputs made on touch screen pad 132, and iii) perform an operation associated with the touch input based on the determined type of the touch input in accordance with embodiments of the present invention. Furthermore, controller 180 may i) obtain coordinate values of a touch input made on touch screen panel 132 of user equipment 100, ii) calculate coordinate information of a pointer on display unit 210 of external device 200 based on the obtained coordinate values, iii) create image data for displaying the pointer on display unit 210 of external device 200 corresponding to the calculated coordinate information, and iv) transmit the created image data to external device 200 in accordance with embodiments of the present invention.

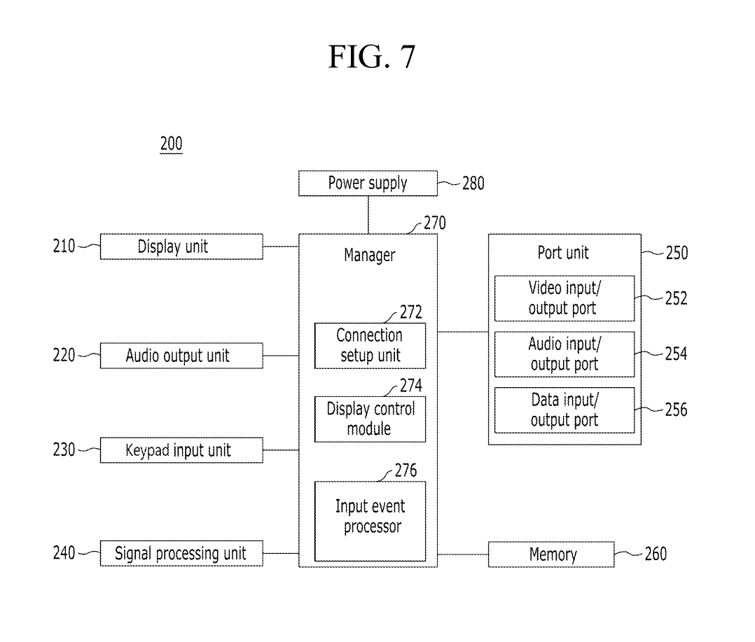

As described above, user equipment 100 may be connected to external device 200 and function as a touch panel or a mouse for external device 200 in accordance with embodiments of the present invention. Hereinafter, external device 200 will be described with reference to FIG. 7.

FIG. 7 shows an external device in accordance with embodiments of the present invention.

Referring to FIG. 7, external device 200 may include display unit 210, audio output unit 220, keypad input unit 230 (keyboard), signal processing unit 240, port unit 250, memory unit 260, manager 270, and power supply 280. Display unit 210, audio output unit 220, touch input unit 230, keypad input unit 235, memory unit 260, and power supply unit 280 may be analogous to, and perform similar functions to, display unit 160, audio output unit 165, input unit 130, internal memory unit 150, and power supply unit 190 of user equipment 100. Accordingly, the detailed description thereof will be omitted herein. For convenience and ease of understanding, only constituent elements performing distinct operations are described herein.

Port unit 250 may be connected to port unit 170 of user equipment 100. That is, port unit 250 may be a connecting port for forming connectivity between user equipment 100 and external device 200. Accordingly, port unit 250 may be a pair relation with port unit 170 of user equipment 100. Port unit 250 may have the same interface configuration of that of port unit 170 of user equipment 100. For example, port unit 250 may have a HDMI port, a USB port, and an audio port.

Port unit 250 may include video input/output port 252, audio input/output port 254, and data input/output port 256. Video input/output port 252 may receive image data from user equipment 100. Audio input/output port 254 may receive audio signals. Data input/output port 256 may exchange data with user equipment 100. Furthermore, port unit 250 may include a power port (not shown) for transferring power to user equipment 100 and a sensing port (not shown) for sensing connection formed between user equipment 100 and external device 200. The present invention, however, is not limited thereto. For example, port unit 250 may be connected to user equipment 100 through a radio link formed between user equipment 100 and external device 200. In this case, port unit 250 may include a signal transmitter and receiver (not shown) for communicating with each other using a communication protocol. Such communication protocol may be Bluetooth, but the present invention is not limited thereto.

Referring back to FIG. 2 and FIG. 3, external device 200 may include coupling bay 251 in accordance with an embodiment of the present invention. Port unit 250 may be disposed on one side of coupling bay 251. Coupling bay 215 may have a space for housing user equipment 100. Such coupling bay 215 may be formed on the same side of key pad input unit 230, but the present invention is not limited thereto. User equipment 100 may be inserted into coupling bay 215. In accordance with embodiments of the present invention, port unit 170 of user equipment 100 may be connected with port unit 250 of user equipment 200 when user equipment 100 is completely inserted into coupling bay 251.

As shown in FIG. 4, user equipment 100 may be partially inserted into coupling bay 215 of external device 200. The present invention, however, is not limited thereto. User equipment 100 may be completely inserted into coupling bay 215 of external device 200 according to a design of coupling bay 215. Furthermore, user equipment 100 may be coupled to external device 200 through a physical cable or a wireless link.

Manager 270 may control overall operation for controlling constituent elements of external device 200 when external device 200 is coupled to user equipment 100. In order to perform such control operation, manager 270 may include connection setup unit 272, display control module 274, and input event processor 276 in accordance with embodiments of the present invention.

Connection setup unit 272 may activate the constituent elements of external device 200 when external device 200 initially senses that external device 200 is connected to user equipment 100. For example, connection setup unit 272 may supply power to the constituent elements of external device 200. That is, connection setup unit 272 may transit a waiting state of external device 200 to a wakeup state of external device 200. Accordingly, connection setup unit 272 may establish a host-device connection between user equipment 100 and external device 200.

External device 200 may provide a graphic user interface about identical to displayed on user equipment 100 when external device 200 is connected to user equipment 100. In such a connected state, image data displayed on display unit 160 of user equipment 100 may be transferred to and displayed on display unit 210 of external device 200. In order to display the transferred image data on display unit 210, manager 270 may include display control module 274. Display control module 274 may turn on display unit 210 under control of manager 270 when external device 200 is connected to user equipment 100. Then, manager 274 may receive the image data displayed on display unit 160 of user equipment 100 from user equipment 100 and display the received image data on display unit 210 of external device 200.

When external device 200 receives input events such as a touch input in a connected state through keypad input unit 230, input event processing unit 276 may generate an event signal corresponding to the input events and transfer the generated event signal to user equipment 100. The generate event signal may be a signal for controlling operation of user equipment 100 corresponding to the received input events.

In accordance with an embodiment of the present invention, external device 200 may not operate in a disconnected mode. The disconnected mode may denote that user equipment 100 is not connected to external device 200. Accordingly, external device 200 may be a dummy device. In this case, external device 200 may include minimum elements for performing essential functions such as display control and touch input control. The present invention, however, is not limited thereto. External device 200 may be embodied as an independent device installed with an operating system (OS) that allows external device 200 operating in a standalone device. For example, external device 200 may operate as a moving image player or a MP3 player when external device 200 is not coupled to user equipment 100. When external device 200 is coupled to user equipment 100, external device 200 may perform certain operations of user equipment 100 in response to the control of user equipment 100 in accordance with embodiments of the present invention.

As described above, external device 200 may be connected to user equipment 100 and perform operations under the control of user equipment 100 in accordance with embodiments of the present invention. Such operation may be performed by exchanging data through port units 170 and 250. Such port units 170 and 250 may be illustrated in FIG. 8. For convenience and ease of understanding, port unit 170 is representatively shown in FIG. 8.

FIG. 8 shows a port unit of user equipment in accordance with an embodiment of the present invention.

Referring to FIG. 8, port unit 170 of user equipment 100 may include HDMI port 610, USB port 620, and audio port 630. HDMI port 610 may include 19 pins for exchanging signals designated to each pin. For example, HDMI port 610 may include hot plug detect (HPD) pin 611. HPD pin 611 may generate a detection signal when user equipment 100 is connected to external device 200. Based on the detection signal generated by HPD pin 611, user equipment 100 may determine that user equipment 100 is connected to external device 200. HDMI port 610 may mainly exchange image data with external device 200. USB port 620 may include 4 pins for mainly exchanging data with external device 200. Furthermore, audio port 630 may include 2 pins for exchanging audio data with external device 200. Although FIG. 8 shows port unit 170 having HDMI port 610, USB port 620, and audio port 630 to connect user equipment 100 with external device 200, the present invention is not limited thereto.

In accordance with an embodiment of the present invention, user equipment 100 is coupled with external device 200 though port unit 170 provided therein. The present invention, however, is not limited thereto. For example, user equipment 100 may be coupled to other electronic devices or appliances such as TV and computer monitors having such HDMI port and/or USB port to output audio/video signals thereto.

After user equipment 100 is coupled to external device 200, user equipment 100 may function as a pointing device, such as a touch pad, for external device 200 in accordance with embodiments of the present invention. For example, user equipment 100 may receive touch inputs from a user through touch screen panel 132 of user equipment 100, display a pointer on display unit 210 of external device 200 corresponding to coordinate values of the touch inputs, and perform operations associated with the touch input in accordance with embodiments of the present invention. Accordingly, user equipment 100 may include a touch screen display unit in accordance with embodiments of the present invention. For example, touch screen panel 132 may be disposed on an upper surface of display unit 160 in order to receive touch inputs from a user, but the present invention is not limited thereto. Hereinafter, such operations for controlling user equipment 100 to function as a touch pad for external device 200 in accordance with embodiments of the present invention will be described with reference to FIG. 9.

FIG. 9 shows a method of controlling user equipment as a touch pad for an external device connected to the user equipment in accordance with embodiments of the present invention.

Referring to FIG. 9, operations may be performed in a standalone mode at step S9010. For example, user equipment 100 may perform operations in response to user inputs in the stand-alone mode when user equipment 100 is not coupled to external device 200. That is, when user equipment 100 is not docked in coupling bay 251, user equipment 100 may operate as a standalone device like a typical smart phone.

At step S9020, determination may be made whether to detect a physical connection to external device 200. For example, such determination may be performed through controller 180 and agent 182 of user equipment 100 based on a detection signal generated in port unit 170 in accordance with embodiments of the present invention. Particularly, port unit 170 of user equipment 100 may be coupled to corresponding port unit 250 of external device 200. User equipment 100 may detect such physical connection to external device 200 based on a detection signal generated at port unit 170 of user equipment 100. As shown in FIG. 8, port unit 170 may include HDMI port 610. In this case, hot plug detect (HPD) pin 611 of HDMI port 610 may generate a HPD signal when HDMI port 610 of user equipment 100 is coupled to port unit 250 of external device 200. The generated HPD signal may be transferred to agent 182 of user equipment 100. Upon the receipt of the HPD signal, agent 182 may determine that external device 200 is connected to user equipment 100. The present invention, however, is not limited thereto. User equipment 100 may detect connection to external device based on communication with external device 200. As shown in FIG. 8, port unit 170 may include USB port 620. In this case, user equipment 100 may communicate with external device 200 through USB port 620 when user equipment 100 is connected to external device 200. Particularly, user equipment 100 may communicate with external device 200 through a USB net and/or an android debug bridge (ADB).

When the physical connection to external device 200 is not detected (No—S9020), user equipment 100 may continuously perform operations in the standalone mode at step S9020.

When the physical connection to external device is detected (Yes—9020), determination may be made whether a pointing device operation mode is initiated or not at step S9030. For example, when controller 180 and agent 182 may determine that a physical connection is established between user equipment 100 and external device 200, controller 180 of user equipment 100 may determine whether a pointing device operation mode is initiated. For example, controller 180 may automatically change an operation mode of user equipment 100 to the pointing device operation mode when the physical connection to external device 200 is detected. Such initiation may be set up in user equipment 100 as default setting. In the pointing device operation mode, user equipment 100 may function as a pointing device for external device 200 connected to user equipment 100. That is, in the pointing device operation mode, user equipment 100 may operate as a touch pad for external device 200 in accordance with embodiment of the present invention.

The operation mode of user equipment 100 is described as being automatically and instantly changed to the pointing device operation mode upon the sensing of the physical connection to external device 200. The present invention, however, is not limited thereto. The pointing device operation mode may be initiated when user equipment 100 receives a certain user input after user equipment 100 is physically connected to external device 200. For example, when a certain user input is received from a user after sensing the connection between user equipment 100 and external device 200, controller 180 of user equipment 100 may change the operation mode of user equipment 100 to the pointing device operation mode in accordance with embodiments of the present invention. The certain input may be at least one of buttons and keys of user equipment 100 or external device 200. Furthermore, the certain input may be at least one of icons and widgets displayed on a default graphic user interface of user equipment 100. As well as single button or key, any combination thereof may be the certain user input that initiates the pointing device operation mode in accordance with embodiments of the present invention. In case of a smart phone, the certain user input may be a home key or a hold key. Particularly, when such certain input is received after user equipment 100 is physically coupled to external device 200, controller 180 may determine that a user wants to use user equipment 100 as a pointing device for external device 200.

When the pointing device operation mode is not initiated (No—S9030), operations may be performed in response to events generated after user equipment 100 is connected to external device 200 at step S9040.

When the pointing device operation mode is initiated (Yes—S9030), display unit 160 may be turned off and generated image data may be transferred to external device 200 connected to user equipment 100 at step S9050. For example, user equipment 100 may be set up to automatically and instantly enter the pointing device operation mode when user equipment 100 is coupled to external device 200 in accordance with embodiments of the present invention. Furthermore, user equipment 100 may change an operation mode to the pointing device operation mode when a certain user input is received in accordance with embodiments of the present invention. When the pointing device operation mode is initiated, user equipment 100 may start function as a touch pad for external device 200 in accordance with embodiments of the present invention. For example, controller 180 may control display controller 164 to turn off display unit 160. Furthermore, controller 180 may transfer image data generated in user equipment 100 to external device 200. The present invention, however, is not limited thereto. Display unit 160 may be not turned off in the pointing device operation mode in accordance with another embodiment of the present invention. After turning off display unit 160, display unit 210 of external device 200 may start displaying image data created in user equipment 100 in accordance with embodiments of the present invention. A user may enter user inputs through various types of input units including touch screen panel 132 in response to information displayed on display unit 210 of external device 200.

At step S9060, touch screen panel 132 may be maintained as turning on in the pointing device operation mode. For example, controller 180 may control touch panel controller 166 to maintain touch screen panel 132 in turning-on when the pointing device operation mode is initiated. If touch screen panel 132 was turned off before the pointing device operation mode is initiated, controller 180 may control touch panel controller 166 to turn on touch screen panel 132 in order to receive touch input from a user. That is, user equipment 100 may be used as a touch pad to receive touch inputs from a user in the pointing device operation mode.

After turning off display unit 160 and maintaining touch screen panel 132 in turning on, inputs may be waited at step S9070. For example, controller 180 of user equipment 100 may wait for inputs from a user through various types of input units including touch screen panel 132. The inputs may be touch inputs made on touch screen panel 132 of user equipment 100 and a release input for releasing user equipment 100 from the pointing device operating mode. Furthermore, the inputs may be other types of inputs made through other input units of user equipment 100 and/or external device 200.

When an input is received, determination may be made as to whether the received input is a touch input made on touch screen panel 132 or not at step S9080. For example, controller 180 of user equipment 100 may determine a type of an input made through various types of input units in accordance with embodiments of the present invention.

When the input is not either of the release input for releasing user equipment 100 from the pointing device operation mode and the touch input (Otherwise—S9080), operations related to the received input may be performed at step S9120 and another input may be waited for at step S9070.

When the input is a touch input made on touch screen panel 132 (Touch input—S9080), a pointer or a cursor may be displayed on display unit 210 of external device 200 according to coordinate values of the touch input at step S9090 and a related operation may be performed according to a type of the touch input at step S9100.

For example, touch input may include various types of inputs, such as a single tap input, a double tap input, a long press input, a tap and drag input, a drag and drop input, and a copy and paste input. Each type of touch input may be designated with a certain operation. For example, the single tap input may be designated with an operation for selecting an object where the single tap input is made on. The long press input may be designated with an operation for executing an object where the long press input is made on. The tap and drag input may be designated with an operation for moving a pointer from one position of the tap input made to another along the drag input made on touch screen panel 132. Accordingly, controller 180 of user equipment 100 may i) determine a type of touch input made on touch screen panel 132, ii) display a pointer or a cursor on display unit 210 of external device 200 based on coordinate values of touch inputs made on touch screen pad 132, and iii) perform an operation associated with the touch input based on the determined type of the touch input in accordance with embodiments of the present invention.

For example, when a user makes a tap and drag input on touch screen panel 132, controller 180 may determine a type of the touch input, which is the tap and drag input. Then, controller 180 may initially display a pointer on display unit 210 of external device 200 corresponding to a position of touch screen panel 132 where the tap input is made. Then, controller 180 may display moving the pointer from the initial position to another along a trace created corresponding to the drag input made on touch screen panel 132.

In order to display a pointer on display unit 210 of external device 200 based on a touch input made on touch screen panel 132 of external device 100, controller 180 may i) obtain coordinate values of a touch input made on touch screen panel 132 of user equipment 100, ii) calculate coordinate information of a pointer on display unit 210 of external device 200 based on the obtained coordinate values, iii) create image data for displaying the pointer on display unit 210 of external device 200 corresponding to the calculated coordinate information, and iv) transmit the created image data to external device 200 in accordance with embodiments of the present invention. The present invention, however, is not limited thereto.

Alternatively, controller 180 may i) obtain coordinate values of a touch input made on touch screen panel 132 of user equipment 100 and ii) transmit the obtained coordinate values of the touch inputs to external device 200 through data input/output port 176 of user equipment 100. In addition, controller 180 may i) obtain coordinate values of a touch input made on touch screen panel 132 of user equipment 100, ii) calculate coordinate information of a pointer on display unit 210 of external device 200 based on the obtained coordinate values, and iii) transmit the calculated coordinate information to external device 200 through data input/output pot 176 of user equipment 100. In this case, external device 200 may create image data based on the received coordinate values of the touch input or the received calculated coordinate information of the pointer. Then, external device 200 may display a pointer on display unit 210 of external device 200 based on the created image data.

User equipment 100 and external device 200 may use different mode for calculating coordinate values for displaying a pointer based on a touch input made on a touch pad. Typically, a smart phone uses an absolute coordinate mode and a laptop computer uses a relative coordinate mode. Since user equipment 100 may be a smart phone and external device 200 may be a tablet PC or a laptop computer, one of the absolute coordinate mode and the relative coordinate mode may be selected for displaying a pointer on display unit 210 of external device 200 based on touch input made on touch screen panel 132 of user equipment 100 in accordance with embodiments of the present invention. When user equipment 100 is connected to external device 200, a user may select one of the absolute coordinate mode and the relative coordinate mode in accordance with embodiments of the present invention. The present invention, however, is not limited thereto. When user equipment 100 is connected to external device 200, one of the absolute coordinate mode and the relative coordinate mode may be automatically selected by default setting of user equipment 100 and/or external device 200. For example, the relative coordinate mode may be selected in accordance with embodiments of the present invention.

In the absolute coordinate mode, an absolute coordinate value of a touch input made on touch screen panel 132 may be used to calculate a coordinate value for displaying a pointer or a cursor on display unit 210 of external device 210. For example, a coordinate value of displaying a pointer on display unit 210 may have one to one mapping relation with the absolute coordinate value of the touch input made on touch screen panel 132. Such an absolute coordinate mode may be used for the following touch inputs, such as a touch input for flipping a page displayed on a display unit and a touch input for enlarging and contracting an image through multi_touch. Such touch inputs may be embodied with absolute coordinate values of related touch inputs. Furthermore, such operation may not require displaying a pointer.

In the relative coordinate mode, the coordinate information of displaying a pointer or a cursor may be calculated based on a relative coordinate value of a touch input. The relative coordinate value of the touch input may be calculated based on an absolute coordinate value of the touch input. For example, the relative coordinate value may be a coordinate value relatively calculated based on an absolute coordinate value of a previous touch input made on touch screen panel 132.

The pointing device operation mode may be initiated by a user through making a certain input. Similarly, the pointing device operation mode may be released by a user through making a similar input. That is, the user may release the pointing device operation mode by making a certain input using at least one of buttons, keys, icons, and widgets of user equipment 100. When the received input is the certain key for releasing the pointing device operation mode (Releasing input—S9080), associated operations for releasing user equipment 100 from the pointing device operation mode may be performed at step S9100. For example, controller 180 may turn back on display unit 160 of user equipment 100 and switch back from the relative coordinate mode to the absolute coordinate mode for receiving touch inputs.

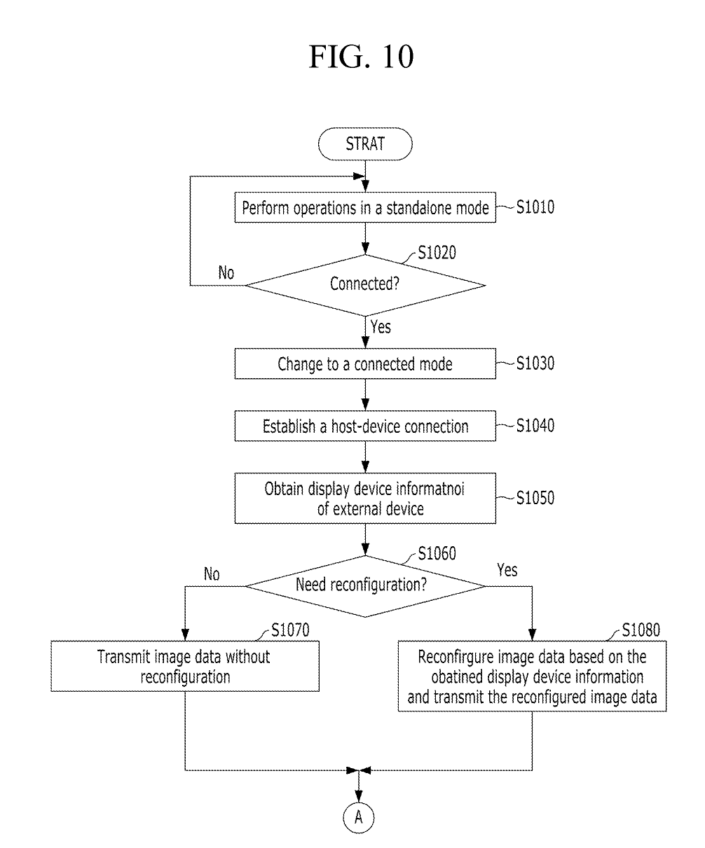

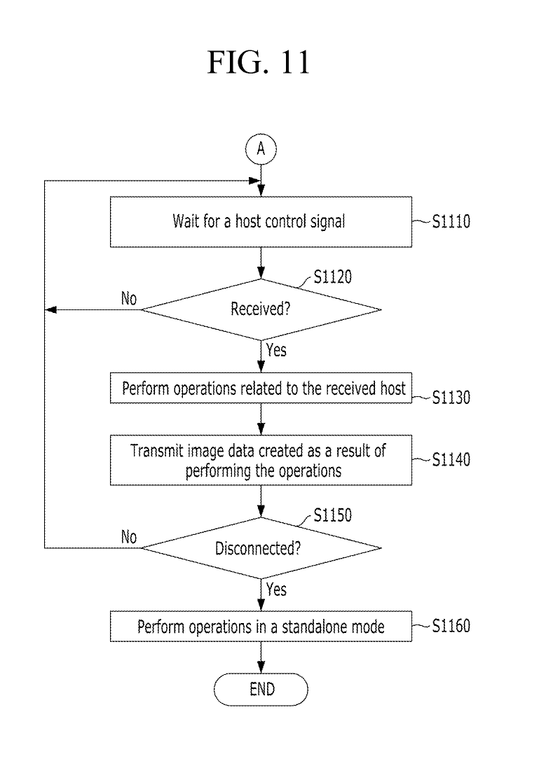

As described above, user equipment 100 may operate as a touch pad for external device 200 when user equipment 100 is connected to external device 200. In order to operate as a touch pad, user equipment 100 may turn off display unit 160 and maintain touch screen panel 132 in turning on. Furthermore, user equipment 100 may change the absolute coordinate mode to the relative coordinate mode and wait for inputs from a user. When the user makes inputs, user equipment 100 may determine a type of touch inputs, display a pointer on display unit 260 of external device 200 according to coordinate information calculated based on touch inputs made on touch screen panel 132, and perform operations associated with the touch inputs. As described, user equipment 100 may perform various operations to provide similar or identical operation environment to user when user equipment 100 is connected to external device 200 in accordance with embodiments of the present invention. Hereinafter, such operations will be described with reference to FIG. 10 and FIG. 11.

FIG. 10 and FIG. 11 show operations of user equipment for providing an operation environment through an external device connected to the user equipment in accordance with embodiments of the present invention.

Referring to FIG. 10, operations may be performed in a standalone mode at step S1010. For example, user equipment 100 may perform operations in response to user inputs in the stand-alone mode when user equipment 100 is not coupled to external device 200. That is, when user equipment 100 is not docked in coupling bay 251, user equipment 100 may operate as a standalone device like a typical smart phone.

At step S1020, determination may be made whether to detect a physical connection to external device 200. For example, when port unit 170 of user equipment 100 is coupled to corresponding port unit 250 of external device 200, user equipment 100 may detect such physical connection to external device 200 based on a detection signal generated at port unit 170 of user equipment 100. The present invention, however, is not limited thereto. User equipment 100 may detect connection to external device based on communication with external device 200.

At step S1030, an operation mode may be changed to a connected mode upon the detection of the physical connection to external device 200. For example, controller 180 may change the operation mode to the connected mode when controller 180 senses the physical connection to external device 200. The connected mode may be opposite to a standalone mode or a disconnected mode. The connected mode may denote an operation mode of user equipment 100 when user equipment 100 is coupled to external device 200. Such connected mode may include the pointing device operation mode.

At step S1040, a host-device connection may be established. For example, controller 180 may establish the host-device connection between user equipment 100 and external device 200. By establishing the host-device connection, an operation environment similar or about identical to that of user equipment 100 may be provided to a user through external device 200. User equipment 100 may be described as a host device in accordance with embodiments of the present invention. The present invention, however, is not limited thereto. External device 200 connected to user equipment 100 may be a host device in accordance with another embodiment of the present invention.

At step S1050, controller 180 may obtain display device information of external device. For example, the display device information of external device 200 may include information on a screen size, a resolution, a display direction, and a dot per inch (DPI) of display unit 210 of external device 200. Such display device information may be obtained through request. Particularly, user equipment 100 may request display unit information to external device 200 and obtain the display unit information from external device 200. Alternatively, user equipment 100 may identify a display unit type of external device 200 and retrieve related display unit information from internal memory 150. Particularly, agent 182 may request and receive display unit information from external device 200. Based on the display unit information, agent 182 may identify hardware specification of display unit 210 of external device 200. For example, agent 182 may receive extended display identification data (EDID) from external device 200. The EDID may be information on hardware specification of display unit 210 of external device 200. The EDID may include information on a manufacturer, a model number, an EDID version, an appropriate DPI value, a screen size, supporting screen resolutions, luminance, and the number of pixels. The present invention, however, is not limited thereto. For example, user equipment 100 may store, in internal memory 150, display unit information of candidate external devices that might be connected to user equipment 100. The stored display unit information may be mapped to a device ID of each candidate external device. Such mapping information may be managed by agent 182 of user equipment 100. In this case, user equipment 100 may receive or recognize a device ID of external device 200. Based on the device ID, user equipment 100 may obtain the display unit information of display unit 210 of external device 200 from the stored display unit information.

At step S1060, determination may be made as to whether it is necessary to reconfigure image data based on the obtained display device information. For example, controller 180 may determine whether it is necessary to reconfigure image data to adjust a resolution of image data based on the obtained resolution information before transmitting the image data to external device 200.

When it is necessary to reconfigure image data (Yes—S1060), image data may be reconfigured based on the obtained display device information and the reconfigured image data may be transmitted to external device 200. For example, controller 180 may reconfigure image data based on a resolution included in the obtained display device information of external device 200. After reconfiguration, the reconfigured image data may be transmitted to external device 200.

When reconfiguration is not necessary (No—S1060), image data may be transmitted to external device without reconfiguration at step S1070. For example, controller 180 may transmit image data without reconfiguring image data based on a resolution of external device 200.

When user equipment 100 operates in a standalone mode, user equipment 100 may create image data based on a resolution set up for display unit 160 of user equipment 100. After user equipment 100 is connected to external device 200, user equipment 100 may create image data for display unit 210 of external device 200. User equipment 100 may be required to reconfigure image data based on a resolution set up for display unit 210 of external device 200. When a resolution of display unit 210 of external device 200 is identical to or compatible to that for display unit 160 of user equipment 100, reconfiguration of image data may be not necessary.

The image data is described as being reconfigured in user equipment 100 and transmitted to external device 200. The present invention, however, is not limited thereto. For example, user equipment 100 may transmit the image data without reconfiguration although the resolution of user equipment 100 is not matched with that of external device 200. In this case, external device 200 may reconfigure the received image data based on the resolution set up for display device 210 of external device 200.

In addition to the resolution, image data may be reconfigured or created based on other parameters included in the obtained display device information, for example, a screen size, a display direction, and a DPI. For example, display unit 160 of user equipment 100 may have a screen size different from display unit 210 of external device 200. In this case, such image date may be reconfigured based on the screen size for display unit 210 of external device 200. Particularly, it may be necessary to change a dot per inch (DPI) for display unit 210 of external device 200. For example, video processing unit 140 may process the image data based on the DPI suitable for display unit 210 of external device 200 and transmit the processed image data to external device 200. Alternatively, controller 180 may transmit image data created for display unit 160 of user equipment 100 to external device 200 without reconfiguration and external device 200 may reconfigure the received image data based on a DPI for display unit 210 of external device 200. Such operation may be performed through signal processing unit 240 of external device 200.

In accordance with embodiments of the present invention, display unit 210 of external device 200 may optimally display images through reconfiguring image data based on a resolution and a DPI of display unit 210 of external device 200. In addition to the resolution and the DPI, a display direction may be considered to create or to reconfigure image data in accordance with embodiments of the present invention.

For example, user equipment 100 such as a smart phone may have a portrait display direction as a default display direction. External devices 200 such as laptop notebook or tablet PC, known as a smart pad, may have a landscape display direction as a default display direction. When such a default display direction is different between user equipment 100 and external device 200, agent 182 may i) obtain information on a default display direction of display unit 210 of external device 200 based on the obtained display unit information including a resolution, a screen size, and product identification and ii) determine whether the default display direction of external device 200 is identical to or different from that of user equipment 100 based on the obtained display device information. When the default display direction is not identical, and iii) controller 180 may reconfigure image data based on the default display direction of external device 200 in addition to the resolution and the DPI of external device 200.

When user equipment 100 is coupled to external device 200, user equipment 100 may generate image data and transfer the generated image data to external device 200. Manager 270 of external device 200 may control operation of external device 200 to display the received image data through display unit 210. Accordingly, a user may be provided with an operation environment similar or identical to that of user equipment 100 through external device 200 when user equipment 100 is connected to external device 200. For example, a user may enter inputs through key pad 230 of external device 200 based on information displayed on display unit 210 of external device 200 in accordance with embodiments of the present invention. Furthermore, a user may make touch inputs on touch screen panel 132 of user equipment 100 based on graphic user interface displayed on display unit 210 of external device 200 in accordance with embodiments of the present invention.

Referring to FIG. 11, after external device 200 displays the reconfigured image data or the image data from user equipment 100, user equipment 100 may wait for a host control signal at step S1110. For example, a user may enter inputs including a touch input through keypad 230 and/or touch screen panel 132 based on information or a graphic user interface displayed on display unit 210 of external device 200. Particularly, input event processor 276 of external device 200 may receive an event generated by receiving inputs through touch screen panel 132 and/or key pad 230 and create a corresponding host control signal. Such host control signal may be transmitted to user equipment 100.

When user equipment 100 receives such host control signal (Yes—S1120), controller 180 of user equipment 100 may perform operation associated with the host control signal at step S1130. Controller 180 may create image data as a result of performing the operation associated with the host control signal. In this case, controller 180 may transmit the created image data to external device 200 at step S1140.

For example, a user may make a double click input on touch input unit 230 in order to run an application installed in user equipment 100. In this case, external device 200 may i) detect the double click input, ii) generate an associated event, iii) generate a corresponding host control signal, and iv) transmit the generated host control signal to user equipment 100. User equipment 100 may i) receive the host control signal, ii) perform operations associated with the host control signal, iii) create image data as a result of performing the operation, and iv) transmit the created image data to external device 200.

The above steps S1110 to S1140 may be repeated until user equipment 100 is disconnected from external device 200. When it is detected that user equipment 100 is disconnected from external device 200 (Yes—S1150), controller 180 may change the connected mode to the standalone mode and perform operations in the standalone mode. For example, when the connected mode is changed to the standalone mode, controller 180 may continuously perform operations through user equipment 100, which were performed through external device 200.

Furthermore, controller 180 may store last states of interrupted operations performed through external device 200 before changing the connected mode to the standalone mode in accordance with embodiments of the present invention. When user equipment 100 is connected to the same external device again, user equipment 100 may continuously perform the interrupted operations performed through the external device based on the stored last states of the interrupted operations by restoring a previous host device connection. After performing the interrupted operations, image data created as the result thereof may be transmitted to the external device 200.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

As used in this application, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, the terms “system,” “component,” “module,” “interface,”, “model” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

The present invention can be embodied in the form of methods and apparatuses for practicing those methods. The present invention can also be embodied in the form of program code embodied in tangible media, non-transitory media, such as magnetic recording media, optical recording media, solid state memory, floppy diskettes, CD-ROMs, hard drives, or any other machine-readable storage medium, wherein, when the program code is loaded into and executed by a machine, such as a computer, the machine becomes an apparatus for practicing the invention. The present invention can also be embodied in the form of program code, for example, whether stored in a storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits. The present invention can also be embodied in the form of a bitstream or other sequence of signal values electrically or optically transmitted through a medium, stored magnetic-field variations in a magnetic recording medium, etc., generated using a method and/or an apparatus of the present invention.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present invention.

As used herein in reference to an element and a standard, the term “compatible” means that the element communicates with other elements in a manner wholly or partially specified by the standard, and would be recognized by other elements as sufficiently capable of communicating with the other elements in the manner specified by the standard. The compatible element does not need to operate internally in a manner specified by the standard.

No claim element herein is to be construed under the provisions of 35 U.S.C. §112, sixth paragraph, unless the element is expressly recited using the phrase “means for” or “step for.”

Although embodiments of the present invention have been described herein, it should be understood that the foregoing embodiments and advantages are merely examples and are not to be construed as limiting the present invention or the scope of the claims. Numerous other modifications and embodiments can be devised by those skilled in the art that will fall within the spirit and scope of the principles of this disclosure, and the present teaching can also be readily applied to other types of apparatuses. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A method for controlling user equipment as a touch pad for an external device connected to the user equipment, the method comprising:
changing an operation mode to a pointing device operation mode when the user equipment is coupled to the external device;
receiving a touch input through a touch screen panel of the user equipment;
displaying a pointer on a display unit of the external device corresponding to a coordinate value of the touch input made on the touch screen panel; and
performing an operation associated with the received touch input.

2. The method of claim 1, wherein the changing an operation mode to a pointing device operation mode includes:
detecting that a physical connection is established between the user equipment and the external device based on a detection signal generated in a port unit of the user equipment; and
automatically initiating the pointing device operation mode upon the detection of the physical connection.

3. The method of claim 1, wherein the changing an operation mode to a pointing device operation mode includes:
detecting that a physical connection is established between the user equipment and the external device based on a detection signal generated in a port unit of the user equipment;
determining whether an initiation input is received after the detecting of the physical connection;
initiating the pointing device operation mode when the initiation key is received; and
otherwise, performing operations in response to events generated after the physical connection.

4. The method of claim 3, wherein the initiation key is:
at least one of buttons and keys of the user equipment and the external device;
at least one of icons and widgets displayed on a graphic user interface displayed on the display device of the external device; and
any combination of the buttons, the keys, the icons, and the widgets.

5. The method of claim 1, wherein the changing includes:
turning off a display unit of the user equipment and starting transmitting image data created in the user equipment to the external device; and
maintaining the touch screen panel in turning on and waiting for an input;

6. The method of claim 1, wherein the receiving a touch input includes:
determining a type of an input when the input is received after initiating the pointing device operation mode; and
when the type of the received input is the touch input, determining a type of the received touch input, displaying a pointer on the display unit of the external device based on coordinate value of the touch input made on the touch screen panel of the user equipment, and performing an operation associated with the determined type of the touch input.

7. The method of claim 6, wherein the determining includes:
determining the type of the input as the touch input when the input is made on the touch screen panel of the user equipment.

8. The method of claim 6, wherein the touch input includes a signal tap input, a double tap input, a long press input, a tap and drag input, a drag and drop input, and a copy and paste input.

9. The method of claim 1, wherein the displaying a pointer includes:
obtaining a coordinate value of the touch input made on the touch screen panel of the user equipment;
calculating coordinate information of the pointer to be displayed on the display unit of the external device based on the obtained coordinate value;
creating image data for displaying the pointer on the display unit of the external device based on the calculated coordinate information;
transmitting the created image data to the external device; and
controlling the external device to display the created image on the display unit of the external device.

10. The method of claim 1, wherein the displaying a pointer includes:
obtaining a coordinate value of the touch input made on the touch screen panel of the user equipment;
transmitting the obtained coordinate value of the touch input to the external device;
controlling the external device to calculate coordinate information of the pointer to be displayed on the display unit of the external device based on the transmitted coordinate value;
controlling the external device to create image data for displaying the pointer on the display unit of the external device based on the calculated coordinate information; and
controlling the external device to display the created image data on the display unit of the external device.

11. The method of claim 1, wherein the displaying a pointer includes:
obtaining a coordinate value of the touch input made on the touch screen panel of the user equipment;
calculating coordinate information of the pointer to be displayed on the display unit of the external device based on the obtained coordinate value;
transmitting the calculated coordinate information of the pointer to the external device;
controlling the external device to create image data for displaying the pointer on the display unit of the external device based on the calculated coordinate information; and
controlling the external device to display the created image data on the display unit of the external device.

12. The method of claim 9, wherein the coordinate value is obtained and the coordinate information is calculated based on one of an absolute coordinate mode and a relative coordinate mode.

13. The method of claim 1, further comprising:
changing an absolute coordinate mode for displaying a pointer corresponding to a touch input to a relative coordinate mode after the user equipment is connected to the external device.

14. A user equipment for operating as a touch pad for an external device connected to the user equipment, the user equipment comprising:
a port unit configured to be connected to a corresponding port unit of the external device and to generate a detection signal when the user equipment is coupled to the external device;
a display unit configured to include a touch screen panel and to receive a touch input from a user through the touch screen panel; and
a controller configured to initiate a pointing device operation mode when the port unit generates the detection signal,
wherein in the pointing device operation mode, the controller is configured to receive touch inputs through the touch screen panel from a user, to control the external device to display a pointer corresponding to the received touch input, to perform operations associated with the received touch inputs, and to control the external device to display a result of performing the operations.

15. The user equipment of claim 14, wherein the controller is configured to initiate the pointing device operation mode when a certain input is received after the user equipment is connected to the external device.

16. The user equipment of claim 14, further comprising:
a display controller configured to turn off the display unit of the user equipment in response to the control of the controller when the pointing device operation mode is initiated; and
a touch screen panel controller configured to maintain the touch screen panel in turning on in response to the control of the controller when the pointing device operation mode is initiated.

17. The user equipment of claim 14, wherein the controller is configured to:
obtain a coordinate value of the touch input made on the touch screen panel;
calculate coordinate information of the pointer to be displayed on the display unit of the external device based on the obtained coordinate value;
create image data for displaying the pointer on the display unit of the external device based on the calculated coordinate information;
transmit the created image data to the external device; and
control the external device to display the created image on the display unit of the external device.

18. The user equipment of claim 17, wherein the controller is configured to use one of an absolute coordinate mode and a relative coordinate mode for obtaining the coordinate value of the touch input and for calculating the coordinate information of the pointer.

19. The user equipment of claim 14, wherein the controller is configured to change an absolute coordinate mode to a relative coordinate mode for displaying a pointer corresponding to a touch input after the pointing device operation mode is initiated.

20. The user equipment of claim 14, wherein the controller is configured to:
obtain a coordinate value of the touch input made on the touch screen panel of the user equipment;
transmit the obtained coordinate value of the touch input to the external device;
control the external device to calculate coordinate information of the pointer to be displayed on the display unit of the external device based on the transmitted coordinate value;
control the external device to create image data for displaying the pointer on the display unit of the external device based on the calculated coordinate information; and
control the external device to display the created image data on the display unit of the external device.
